(19) United States
(12) Patent Application Publication
(10) Pub. No.: US 2017/0274421 A1
(43) Pub. Date: Sep. 28, 2017

(54) CLEANER FOR A PLANSIFTER SIEVE

(71) Applicant: Norvell Company, Inc., Fort Scott, KS (US)

(72) Inventor: Mark Eugene Shank, Redfield, KS (US)

(21) Appl. No.: 15/467,868

(22) Filed: Mar. 23, 2017

Related U.S. Application Data
(60) Provisional application No. 62/312,183, filed on Mar. 23, 2016.

(51) Int. Cl. B07B 1/52

(52) U.S. Cl. CPC B07B 1/526

(57) ABSTRACT

A cleaning device for a sieve box is provided. The cleaning device can include outer members configured together to form a perimeter, a central region located within the perimeter and interior members connecting the perimeter and the central region. The cleaning device can include nubs provided on the bottom surface of the outer members and the interior members. The nubs can be spaced apart across the lengths of the outer and interior members and can include terminal ends. The terminal ends of the nubs can have rounded, flattened or pointed shapes based on the intended aggressiveness of the cleaning device. The cleaning device can be adapted for placement on a sieve screen of the sieve box and move across the sieve screen to remove milling product stuck to the sieve screen, break apart clumped milling product, and/or push excess milling product toward a discharge zone of the sieve box.

### CROSS-REFERENCE TO RELATED APPLICATIONS

This Application claims priority to U.S. Provisional Patent Application Ser. No. 62/312,183, filed on Mar. 23, 2016, to Mark E. Shank, entitled “Cleaner for a Plansifter Sieve,” currently pending, the entire disclosure of which is incorporated herein by reference.

### FIELD OF THE INVENTION

The present invention is directed generally toward cleaning devices, and particularly toward a cleaning device for a plansifter sieve, a sieve box or other sifting apparatus.

### BACKGROUND

Devices for sorting and separating granular materials by particle size are well known in the art. One such device is commonly referred to as a plansifter. Plansifters typically include a number of sieve boxes that are stacked or otherwise generally arranged one above another. Each sieve box includes a woven screen or clothing applied to a top end of the box. The mesh sizes of the screens vary from course to fine. When movement is applied to the plansifter, particulates that are smaller than a screen's mesh size are able to flow through the screen and settle on a pan located underneath the screen. Those particulates then move along the pan, exit the sieve box, and may then be directed to a lower sieve box having a smaller mesh size screen applied thereon. However, courser particulates that are larger than a screen's mesh size move along the top of the screen to a discharge channel that is located along a side of the sieve box.

Many materials have poor sifting properties due to their moisture content, their oil or fat content, the high humidity required for mill processing or other material properties or factors. The particulates of such materials are known to stick to one another or amalgamate thereby forming clumps or balls of materials on the top surface of the screen. These clumps or balls of particulate material are of a large enough size that they are unable to flow through the screen. Thus, they are discharged from the sieve and are often times directed back to a mill or grinder, thereby placing an otherwise unnecessary load on the mill or grinder. The particulates of such materials are also known to bind or adhere to the surface of the screen and create product buildup on the screen that can block the screen openings and reduce the effectiveness of the sifting process.

Known plansifter sieves include cleaners that are adapted for placement in the finished product zone (i.e., the area underneath the screen) of the sieve boxes and are, therefore, not suitable for addressing the aforementioned issues that occur above the screen. Additionally, if a cleaner located in the finished product zone were to chip or break apart, pieces of that cleaner could get into the finished product.

Accordingly, a need has arisen for a new and innovative cleaning device for a plansifter sieve, a sieve box, or other sifting apparatus that (i) can reduce or prevent plugging or blinding of the screen, (ii) can reduce or prevent clumping or balling of material on the top surface of the screen, (iii) can aid in the grinding of the material, (iv) can assist in conveying material across the screen, and/or (v) can be located outside of the finished product zone.

### SUMMARY OF THE INVENTION

The present invention is directed to a cleaning device for a sieve box of a plansifter or other sifting apparatus. The cleaning device can be configured to be placed on the top surface of a sieve screen of the sieve box (and outside the sifted product zone) and configured to move across the sieve screen to clean the sieve screen, remove particles from the sieve screen, break up clumped particles on the surface of the screen, and/or direct particles on the sieve screen to a discharge channel.

According to one embodiment of the present invention, the cleaning device can comprise one or more outer members forming a frame portion that can define the outer perimeter of the cleaning device, a central region positioned within the interior of the frame portion, and one or more interior members extending between the outer members and the central region. The cleaning device can also comprise one or more crossing members extending between two of the outer members and intersecting one or more of the interior members. Collectively, the outer members, the central region and the interior and crossing members can form one or more void spaces within the interior of the cleaning device.

The cleaning device can further comprise a plurality of nubs protruding from a bottom surface of the cleaning device. The nubs can be spaced apart along the lengths of the outer members, the interior members and/or the crossing members. The nubs can be configured to engage the top surface of the sieve screen and move across the sieve screen to remove milling product adhered to the sieve screen and/or break up clumps of milling product particles that have developed on the surface of the sieve screen.

Depending on the particular embodiment of the cleaning device, the nubs can have terminal ends with differently shaped configurations. According to one embodiment, the terminal ends of the nubs can have a rounded configuration. According to another embodiment, the terminal ends of the nubs can have a flattened configuration. According to another embodiment, the nubs can have a pointed configuration. Other embodiments of the present invention can utilize other configurations of the terminal ends of the nubs. The configuration of the terminal ends of the nubs can be configured to affect the aggressiveness level of the particular embodiment of the cleaning device. In certain embodiments of the present invention, a more rounded shape of the nubs can apply less force to the sieve screen while a more pointed shape can apply a greater force to the sieve screen.

The cleaning device can additionally include one or more ribs provided on the bottom surface of cleaning device to provide increased rigidity and structural stability to the outer and interior members. According to one embodiment of the present invention, the ribs can extend along the bottom surface of one or more of the interior members and can be positioned adjacent to the outer portions of the cleaning device. The ribs can additionally extend through and be aligned with the nubs provided on the interior members. In other embodiments of the present invention, additional ribs can be provided on the outer members of the cleaning device to further increase the structural stability of the cleaning device.

The cleaning device can be configured into any desirable shape and can be shaped to fit within the perimeter of the sieve screen. According to certain embodiments, the cleaning device can be configured into a diamond shape, a kite shape, a circular shape, a rectangular shape with one or more pointed sides or any other desirable shape.

Other aspects and advantages of the present invention will be apparent from the following detailed description of the preferred embodiments and the accompanying drawing figures.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a top perspective view of a cleaning device in use with a sieve box in accordance with one embodiment of the present invention;

FIG. 2A is a bottom plan view of a cleaning device for a sieve box in accordance with one embodiment of the present invention;

FIG. 2B is a bottom plan view of a cleaning device for a sieve box in accordance with another embodiment of the present invention;

FIG. 3A is a section view of the cleaning device of FIG. 2A taken about line 3-3 and illustrating a nub provided on the cleaning device in accordance with one embodiment of the present invention;

FIG. 3B is a section view of the cleaning device of FIG. 2A taken about line 3-3 and illustrating a nub provided on the cleaning device in accordance with another embodiment of the present invention;

FIG. 3C is a section view of the cleaning device of FIG. 2A taken about line 3-3 and illustrating a nub provided on the cleaning device in accordance with yet another embodiment of the present invention;

FIG. 4A is a section view of the cleaning device of FIG. 2A taken about line 4-4 and illustrating a nub and a rib provided on the cleaning device in accordance with one embodiment of the present invention;

FIG. 4B is a section view of the cleaning device of FIG. 2A taken about line 4-4 and illustrating a nub and a rib provided on the cleaning device in accordance with another embodiment of the present invention;

FIG. 4C is a section view of the cleaning device of FIG. 2A taken about line 4-4 and illustrating a nub and a rib provided on the cleaning device in accordance with yet another embodiment of the present invention;

FIG. 5 is a section view of the cleaning device of FIG. 2A taken about line 5-5 and illustrating nubs provided on the cleaning device in accordance with one embodiment of the present invention;

FIG. 6A is a bottom plan view of a cleaning device for a sieve box in accordance with one embodiment of the present invention;

FIG. 6B is a bottom plan view of a cleaning device for a sieve box in accordance with another embodiment of the present invention;

FIG. 7 is a top perspective view of a cleaning device in use with a sieve box in accordance with one embodiment of the present invention;

FIG. 8 is a bottom plan view of a cleaning device for a sieve box in accordance with one embodiment of the present invention;

FIG. 9 is a bottom plan view of a cleaning device for a sieve box in accordance with another embodiment of the present invention;

FIG. 10A is a section view of the cleaning devices of FIGS. 8 and 9 taken about line 10-10 and illustrating a nub provided on the cleaning device in accordance with one embodiment of the present invention;

FIG. 10B is a section view of the cleaning devices of FIGS. 8 and 9 taken about line 10-10 and illustrating a nub provided on the cleaning device in accordance with another embodiment of the present invention;

FIG. 10C is a section view of the cleaning devices of FIGS. 8 and 9 taken about line 10-10 and illustrating a nub provided on the cleaning device in accordance with another embodiment of the present invention;

FIG. 11A is a section view of the cleaning devices of FIGS. 8 and 9 taken about line 11-11 and illustrating a nub provided on the cleaning device in accordance with one embodiment of the present invention;

FIG. 11B is a section view of the cleaning devices of FIGS. 8 and 9 taken about line 11-11 and illustrating a nub provided on the cleaning device in accordance with another embodiment of the present invention;

FIG. 11C is a section view of the cleaning devices of FIGS. 8 and 9 taken about line 11-11 and illustrating a nub provided on the cleaning device in accordance with another embodiment of the present invention; and

FIG. 12 is a top perspective view of a cleaning device in use with a pneumatic sieve box in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures. It will be appreciated that any dimensions included in the drawing figures are simply provided as examples and dimensions other than those provided therein are also within the scope of the invention.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

The present invention is directed to a cleaning device 10 that can be configured for use with a sieve box 100 or other sifting component. Sieve boxes 100 are commonly used with plansifters or particulate sifters for sifting milled products such as flour, oats, cereal grains, wheat, corn, rye, barley, rice, walnuts and other nuts, and the like. Sieve boxes 100 (and cleaning device 10) can also be used with other granular milling products including those used in cosmetics, such as guar bean, guar gum, or guar splits, and products used in industrial applications such as sand, sand for drilling mud, soil, plastics, and any other products that are sorted by particle size using a sieve.

Plansifters or particulate sifters generally incorporate multiple sieve boxes 100 for separating different sized particles of the milled product. Each sieve box 100 includes a sieve screen 106 configured to allow a certain size particle to pass therethrough while larger particles may be forced back into the milling process. Typically, the plansifters use a gyrating or other motion to sift the milling product through the plurality of sieve boxes 100 until the finished milling product includes particles of a desired particle size. Cleaning device 10 can be used to increase the sifting capacity of sieve boxes 100 (and plansifters) when processing hard to shift milling products by cleaning the sieve screen 106 provided on the sieve boxes 100. Cleaning device 10 can be used to reduce or prevent plugging or binding of the sieve screen 106, reduce or prevent clumping or balling of material on the top surface of the screen 106, aid in grinding of the material as it passes through the sieve box 100, and/or assist in conveying certain material across the screen 106 (e.g., material that cannot fit through the openings in the screen 106 of the sieve box 100).

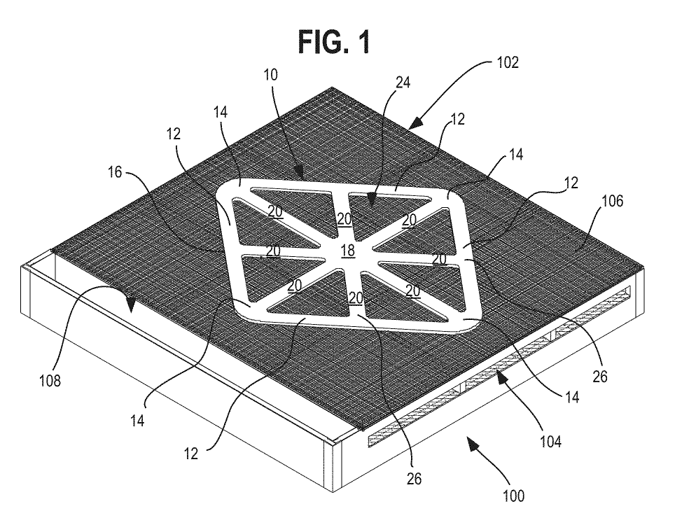

FIG. 1 shows cleaning device 10 according to one embodiment of the present invention positioned on a typical sieve box 100. As shown in FIG. 1, sieve box 100 can include a box frame portion 102 defining a perimeter of sieve box 100, a sifted product zone 104 located within box frame portion 102 and a sieve screen 106. Sieve screen 106 can comprise any suitable type of sifting structure (such as mesh, clothing, fabric, wireframe or the like) with a plurality of sized openings to allow particulates of a specific size to pass therethrough. A milling product introduced to sieve box 100 can be placed on sieve screen 106 and particulates with the appropriate particle size may be sifted through the sized openings in sieve screen 106 and into sifted product zone 104, where it can be transferred to an additional sieve box 100. As further shown in FIG. 1, sieve box 100 can also include a discharge zone 108 that can receive rejected milling particulates too large to pass through sieve screen 106. Discharge zone 108 can transfer the larger particles away for further mill processing or grinding.

As illustrated in FIG. 1, cleaning device 10 can be configured to be placed on the top of sieve screen 106 of sieve box 100. Cleaning device 10 can move across sieve screen 106 between the edges of frame portion 102 in order to clean sieve screen 106 by removing milling product that has adhered to sieve screen 106, begun to clump together and/or started to blind screen 106. Cleaning device 10 can additionally break apart clumped milling product and direct clumped milling product and milling particulates too large to pass through sieve screen 106 to discharge channel 108 for further processing. As best illustrated in FIG. 1, cleaning device 10 can be located on top of sieve screen 106 and outside of the sifted or finished product zone 104. As further illustrated in FIG. 1, cleaning device 10 can have an outer perimeter (defined by a frame portion 16) configured to fit completely within box frame portion 102 and sieve screen 106 of sieve box 100 and configured to cover all or a majority of the area of sieve screen 106 when cleaning device 10 is in movement.

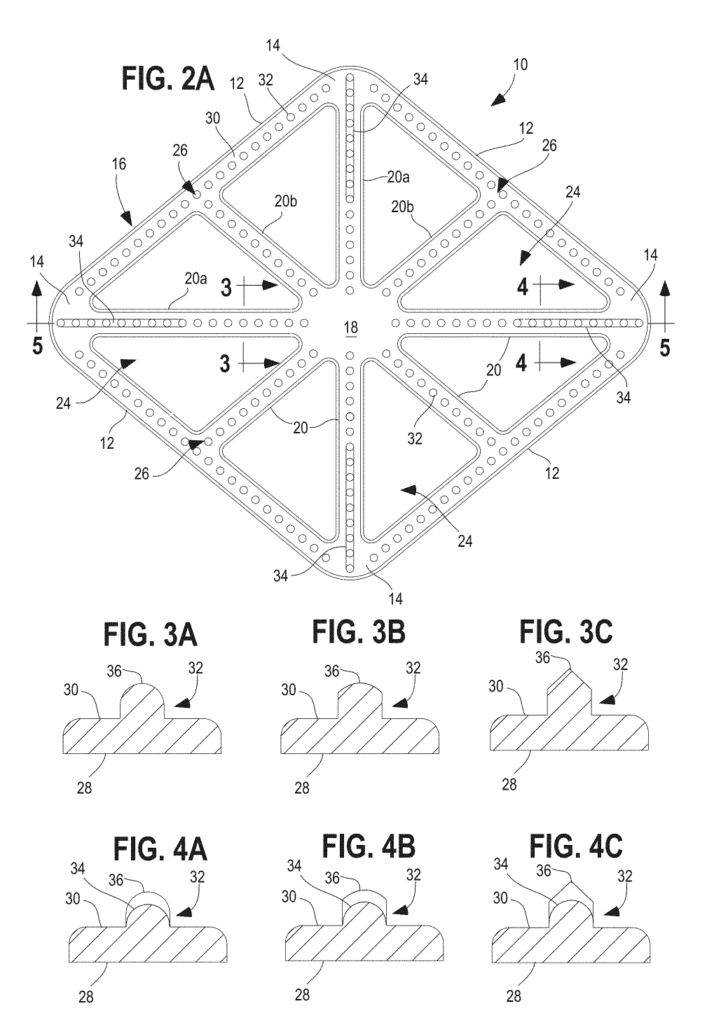

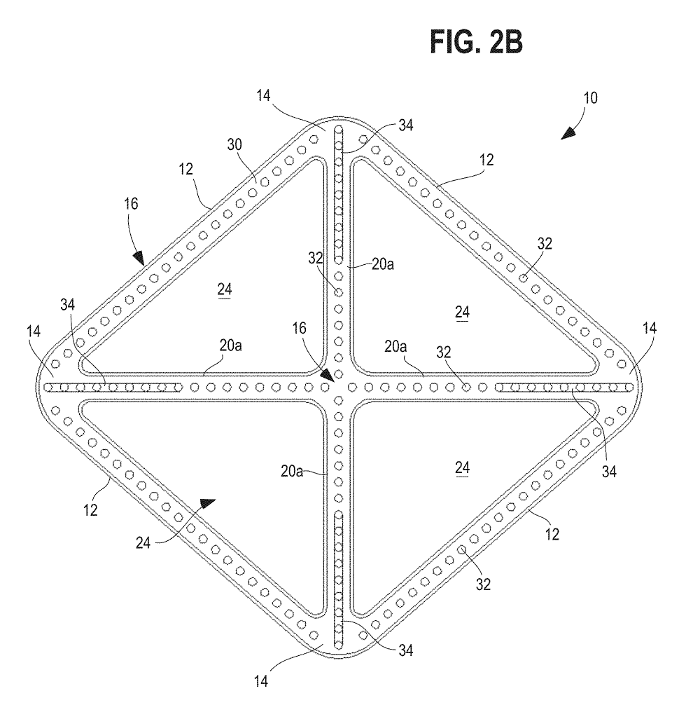

Turning to FIGS. 2-5, cleaning device 10 according to one embodiment can comprise one or more outer members 12, a central node or region 18 and one or more interior members 20. As shown in FIG. 2A, outer members 12 can be configured together to form an outer frame portion 16 that can define the perimeter of cleaning device 10. Central region 18 can be positioned within the perimeter formed by outer members 12 and frame portion 16. Interior members 20 can be configured to extend between frame portion 16 and central region 18.

As shown in FIG. 2A, outer members 12 can comprise elongated arms, slats, beams, bars or similar structures and can connect together or intersect at interesting nodes 14. As further shown in FIG. 2A, interior members 20 can have a similar elongated beam configuration as outer members 12 and can connect to one or more outer members 12 at one end and central region 18 at the other end. However, it is recognized that in alternative embodiments of the present invention, outer members 12 and interior members 20 can any number of different suitable shapes, orientations and/or configurations.

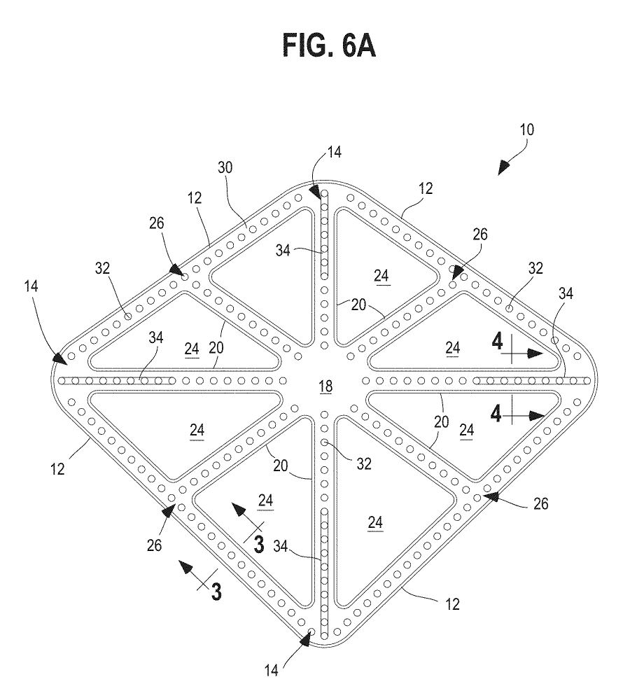

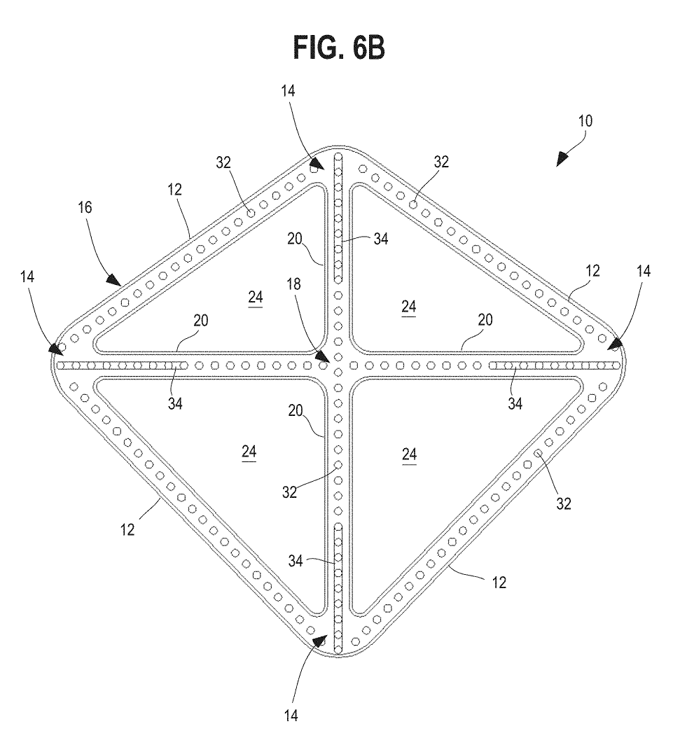

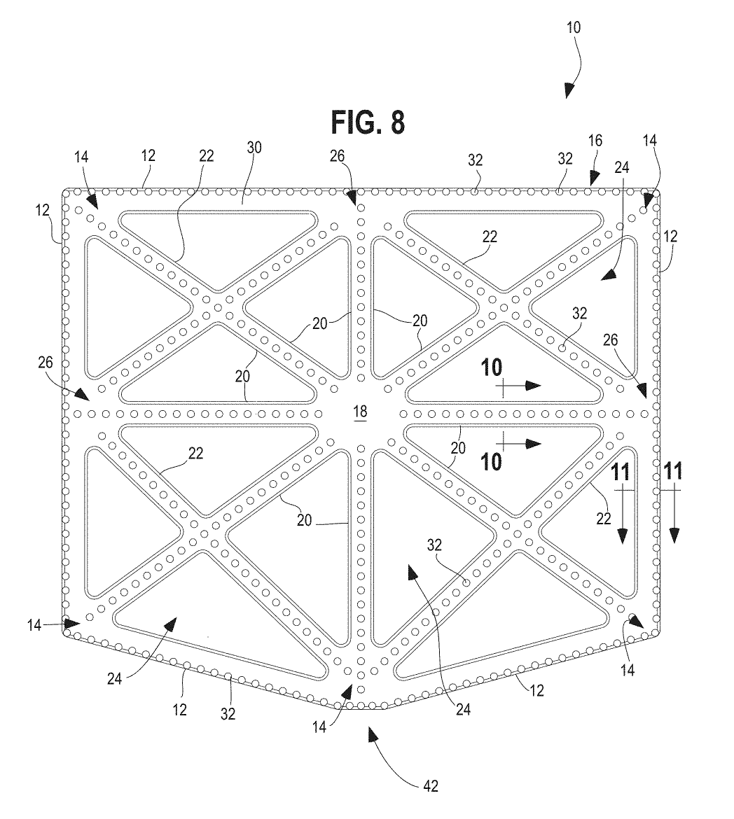

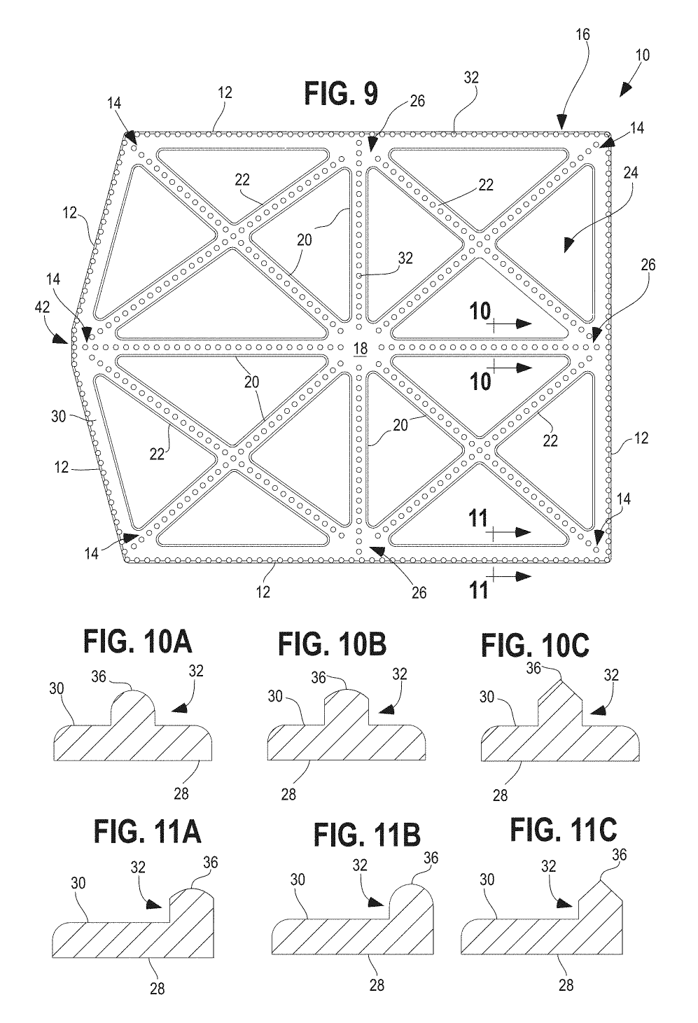

Depending on the particular embodiment of the present invention, cleaning device 10 and frame portion 16 can have any suitable shape or configuration. According to the embodiments shown in FIGS. 2A and 2B, cleaning device 10 can have a diamond or rhombus shape. According to the embodiments shown in FIGS. 6A, 6B, 8, 9 and 12, cleaning device 10 and frame portion 16 can have a kite shape (FIGS. 6A and 6B), a rectangular or irregular pentagon shape (FIGS. 8 and 9), or a rounded rectangular shape (FIG. 12), for example. According to other alternative embodiments (not shown) cleaning device 10 can have any other suitable three, four, or five or more sided, or rounded or circular geometric shape suitable for placement on a sieve screen 106. The shape and configuration of cleaning device 10 can be configured based on the shape and configuration of sieve box 100 (and sieve screen 106 provided thereon) and can further be configured and shaped to allow for optimal coverage, movement and/or weight distribution when cleaning device 10 is in use with sieve box 100.

According to one embodiment, cleaning device 10 can include primary interior members 20a and secondary interior members 20b. As best shown in FIG. 2A, primary interior members 20a can extend between outer intersecting nodes 14 (that connect the ends of outer members 12 together) and central region 18. As also best shown in FIG. 2A, secondary interior members 20b can extend between intermediate intersecting nodes 26 located at intermediate positions along a length of an outer member 12 and central region 18. According to another embodiment, as best shown in FIG. 2B, cleaning device 10 can be configured with only primary interior members 20a extending between intersecting nodes 14 and central region 18. FIG. 2B illustrates an alternative embodiment of cleaning device 10 that can be configured in a manner similar to the embodiment illustrated in FIG. 2A. However, as shown in FIG. 2B, cleaning member 10 can include one or more primary interior members 20a extending between intersecting nodes 14 (located at the ends of two outer members 12) and central region 18 without any secondary members 20b extending toward central region 18 from intermediate positions along outer members 12. As further shown in FIG. 2B, in certain embodiments of cleaning member 10, central region 18 can be configured with a reduced size (compared to the embodiment of cleaning device 10 illustrated in FIG. 2A) and can comprise a central node 18 where interior members 20 connect together or intersect one another. In alternative embodiments, cleaning device 10 can have alternative arrangements and configurations of interior members 20. According to certain embodiments, interior members 20 (along with outer members 12 and central region 18) can be configured and positioned to provide a more even weight distribution of cleaning device 10.

As shown in FIGS. 2A and 2B, cleaning device 10 can include one or more void spaces 24 provided within the interior of frame portion 16. Void spaces 24 can be fat tied between outer members 12 and interior members 20 and central region 18. As illustrated in FIGS. 2A and 2B according to one embodiment, void spaces 24 have triangular shape due to the configuration and orientation of cleaning device 10; however, void spaces 24 can have any suitable alternative shape based on the orientation and configuration of cleaning device 10, outer members 12, interior members 20 and central region 18.

As shown in FIGS. 2-5, cleaning device 10 can include a top surface 28 and a bottom surface 30. Bottom surface 30 can be configured to face sieve screen 106 when cleaning device 10 is placed on sieve box 100. As shown in the several figures, top surface 28 and bottom surface 30 can have a generally flat and/or uniform shape. In alternative embodiments of the present invention, top and bottom surfaces 28 and 30 can have any suitable type of configuration.

As shown in FIGS. 2-5, cleaning device 10 can include a plurality of nubs 32 extending from outer members 12 and interior members 20. Nubs 32 can be configured to contact sieve screen 106 of sieve box 100 when cleaning device 10 is positioned on sieve screen 106. Nubs 32 can function to engage and clean sieve screen 106, impact milling product and particles contained on sieve screen 106 in order to break up or grind the milling product, and/or direct the milling products across sieve screen 106.

Nubs 32 can be configured as nubs, knobs, tips, fingers or other protrusions intermittently spaced throughout cleaning device 10. Nubs 32 can additionally be varied in number, location, size and shape depending on the particular use and application of cleaning device 10 and sieve box 100. Nubs 32 can additionally be strategically configured to provide a desired aggressiveness level of engagement to sieve screen 106 (as described in greater detail below). For example, for milling products that significantly build up on sieve screen 106 and can be difficult to break apart, cleaning device 10 can be configured with nubs 32 having a more aggressive level to sufficiently clean screen 106. For milling products that do not significantly bind to sieve screen 106, cleaning device 10 can be configured with nubs 32 having a less aggressive level in order to reduce the wear and tear and impact on sieve screen 106 while still effectively removing the milling product from sieve screen 106.

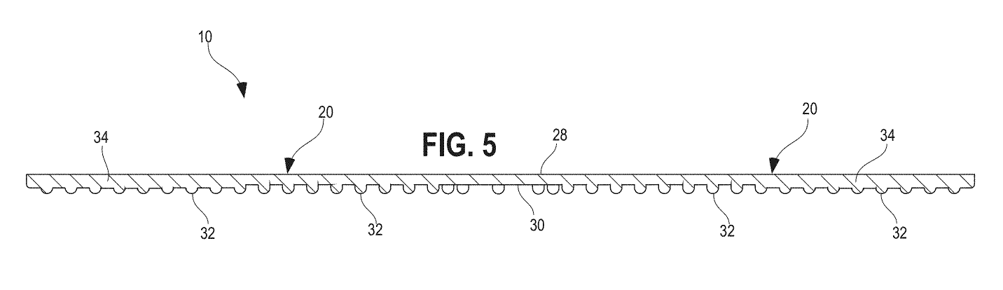

FIG. 2A shows a bottom plan view of cleaning device 10, according to one embodiment of the present invention, where cleaning device 10 includes a plurality of nubs 32 protruding from bottom surface 30. As best shown in FIGS. 2 and 5, nubs 32 can be spaced apart along the lengths of outer members 12 and interior members 20. Nubs 32 can additionally be provided on outer intersecting nodes 14, central region 18 and intermediate intersecting nodes 26 in certain embodiments of the present invention.

According to one embodiment, nubs 32 can be generally evenly spaced apart along the lengths of outer members 12 and interior members 20, as shown in FIG. 5, in order to provide generally even pressure and weight distribution of cleaning device 10 to sieve screen 106. However, in alternative embodiments, nubs 32 can be unevenly spaced to apply greater pressure at specific portions of cleaning device 10 to sieve screen 106. Nubs 32 can also be provided in different sizes and shapes in different locations on cleaning device 10 in particular embodiments of the present invention. As also shown in FIG. 2A, nubs 32 can be generally centrally located along the width of outer and interior members 12 and 20 and generally evenly spaced from each edge of outer and interior members 12 and 20.

FIGS. 3A-3C and 4A-4C show cross-sectional views of outer members 12 and interior members 20 of cleaning device 10 according to various exemplary embodiments to illustrate nubs 32 in greater detail. As shown in FIGS. 3A through 4C, each nub 32 can have a terminal end 36 configured to engage the top surface of sieve screen 106 of sieve box 100 (as shown in FIG. 1). According to one exemplary embodiment as shown in FIGS. 3A and 4A, terminal ends 36 of nubs 32 can have a rounded or arcuate shape. According to yet another exemplary embodiment as shown in FIGS. 3B and 4B, terminal ends 36 of nubs 32 can have a more flattened shape having more defined edges and a slightly curved profile. According to another exemplary embodiment as shown in FIGS. 3C and 4C, terminal ends 36 of nubs 32 can have a more pointed shape with angled surfaces. In other embodiments (not shown), terminal ends 36 of nubs 32 can have various other configurations, such as a multi-pointed shape, a rectangular shape, a rounded convex shape or any other desired configuration, shape, size or height. In addition, in certain exemplary embodiments, cleaning device 10 can be configured with any desirable combination of nubs 32 having rounded, flattened, pointed or other differently shaped terminal ends 36.

The different shapes of terminal ends 36 of nubs 32 can be configured to affect the aggressiveness level of cleaning device 10 relative to sieve screen 10. According to the embodiment shown in FIGS. 3A and 4A, where terminal ends 36 have a rounded shape, nubs 32 (and cleaning device 10) can be configured to create more gentle contact with sieve screen 106 and apply less force to sieve screen 106. Cleaning device 10 according to such an embodiment can be configured to reduce the wear and tear applied to sieve screen 106 and/or be configured for use where only moderate force is necessary to remove and/or break apart milling product buildup on sieve screen 106.

According to the embodiment shown in FIGS. 3B and 4B, where terminal ends 36 have a more flattened shape, nubs 32 (and cleaning device 10) can be configured to create more aggressive contact with sieve screen 106 and apply an increased force to sieve screen 106. Cleaning device 10 according to such an embodiment can be configured for use where a greater force is needed to remove and/or break apart milling product buildup on sieve screen 106, such as with milling products having a greater moisture component.

According to the embodiment shown in FIGS. 3C and 4C, where terminal ends 36 have a more pointed shape, nubs 32 (and cleaning device 10) can be configured to create even more aggressive contact with sieve screen 106 and apply an even greater force to sieve screen 106. Cleaning device 10 according to such an embodiment can be configured for use where substantial force is needed to effectively remove and/or break apart milling product buildup on sieve screen 106. For example, cleaning device 10 can be configured with nubs 32 having pointed-shaped terminal ends 36 when sieve box 100 is configured for sifting walnuts or oat flour, where substantial milling product buildup can occur on sieve screen 106 as a result of the moisture, oil and/or fat content contained within the milling product.

Turning to FIGS. 2A and 2B, 4A-4C and 5, cleaning device 10 according to one embodiment of the present invention can include an elongated rib 34 on one or more interior members 20 (and/or outer members 12). Ribs 34 can be configured to provide increase rigidity and structural stability to cleaning device 10. As best shown in FIG. 2, ribs 34 can be located on bottom surfaces 30 of primary interior members 20a and extend along at least a portion of the lengths of primary interior members 20a. As best shown in FIGS. 4A-4C and FIG. 5, ribs 34 can be generally aligned with and extend through one or more nubs 32 provided on interior members 20. As also shown in FIGS. 4A-4C and FIG. 5, ribs 34 can extend from bottom surface 30 of interior members 20 a depth less than the depth of nubs 32 so that ribs 34 do not obstruct engagement between terminal ends 36 of nubs 32 and sieve screen 106 of sieve box 100. In certain embodiments of the present invention, ribs 34 can be configured as regions of members 12 and/or 20 with an increased thickness relative to the remainder regions of members 12 and/or 20.

FIG. 6A illustrates an alternative embodiment of cleaning device 10 configured with a kite shape. As shown, cleaning device 10 according to such an embodiment can comprise a plurality of outer members 12 connected together at intersecting nodes 14 to form frame portion 16. As also shown in FIG. 6A, central region 18 of cleaning device 10 according to such an embodiment can be slightly offset within the interior of frame portion 16 toward one side of cleaning device 10. As a result, interior members 20 extending between outer members 12 and central region 18 on one side of cleaning device 10 can have a greater length than the interior members 20 on the opposing side of cleaning device 10. FIG. 6B illustrates another alternative embodiment of cleaning device 10 configured and shaped similar to the embodiment illustrated in FIG. 6A. As shown in FIG. 6B, according to one embodiment, cleaning device 10 can be configured with a central node 18 having a reduced size and comprising the connection and/or intersection of interior members 20. As also shown in FIG. 6B, according to such an embodiment, cleaning device 10 can be configured with only primary interior members 20 extending between intersecting nodes 14 and central node 18 (as opposed to including additional secondary interior members 20 extending between intermediate intersecting nodes 26 and central region 18 as shown in the embodiment of FIG. 6A).

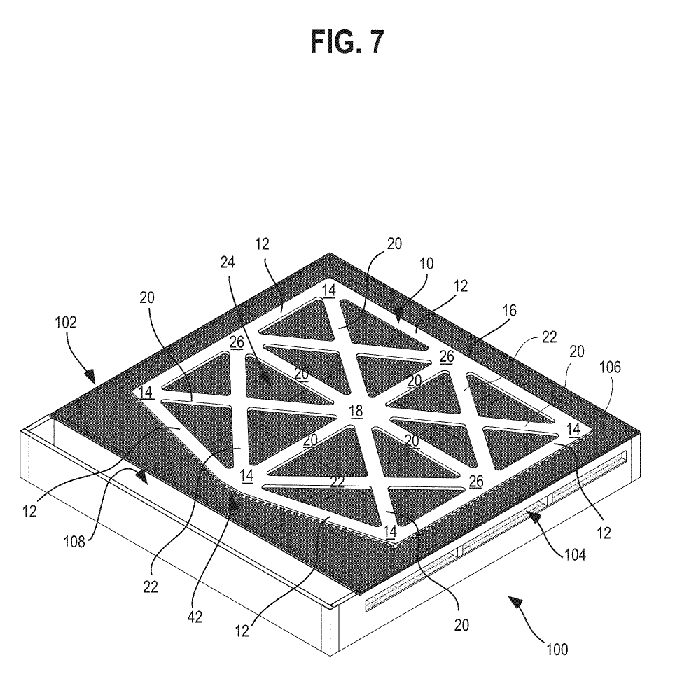

FIGS. 7 through 9 illustrate other alternative embodiments of cleaning device 10 configured with a more rectangular and/or irregular pentagon shape. As best shown in FIGS. 7 and 9, cleaning device 10 according to such an embodiment can include a plurality of outer members 20 configured into a generally rectangular and orthogonal orientation. In addition, cleaning device 10 can include two oppositely angled outer members 12 provided on one or more sides of frame portion 16. The two oppositely angled outer members 12 can be connected together at an intersecting node 14 in order to form a point 42 along one side cleaning device 10. According to one embodiment, as best shown in FIG. 7, point 42 can be orientated toward discharge zone 108 of sieve box 100 when cleaning device 10 is placed onto sieve screen 106. Such a configuration can be beneficial in that it can reduce obstruction to discharge zone 108 and can assist in conveying milling product unable to sift through sieve screen 106 toward discharge zone 108. FIG. 9 illustrates another embodiment of cleaning device 10 configured similar to the embodiment shown in FIGS. 7 and 8 except angled outer members 12 and point 42 are located on a longer side of the rectangular-shaped cleaning device 10.

As shown in FIGS. 7 through 9, cleaning device 10 can include a plurality of interior members 20 extending between intersecting nodes 14 and 26 provided along frame portion 16 and central region 18. In addition, cleaning device 10 can include one or more crossing members 22 extending between two intersecting nodes 14 or 26 provided along frame portion 16. As shown in FIGS. 7 through 9, crossing members 22 can intersect interior members 20 to form additional void spaces 24 within the interior of cleaning device 10 and to provide greater structural stability and weight distribution to cleaning device 10. As best shown in FIGS. 8 and 9, crossing members 22 can also have nubs 32 extending from bottom surface 30 in a manner similar to outer members 12 and interior members 20.

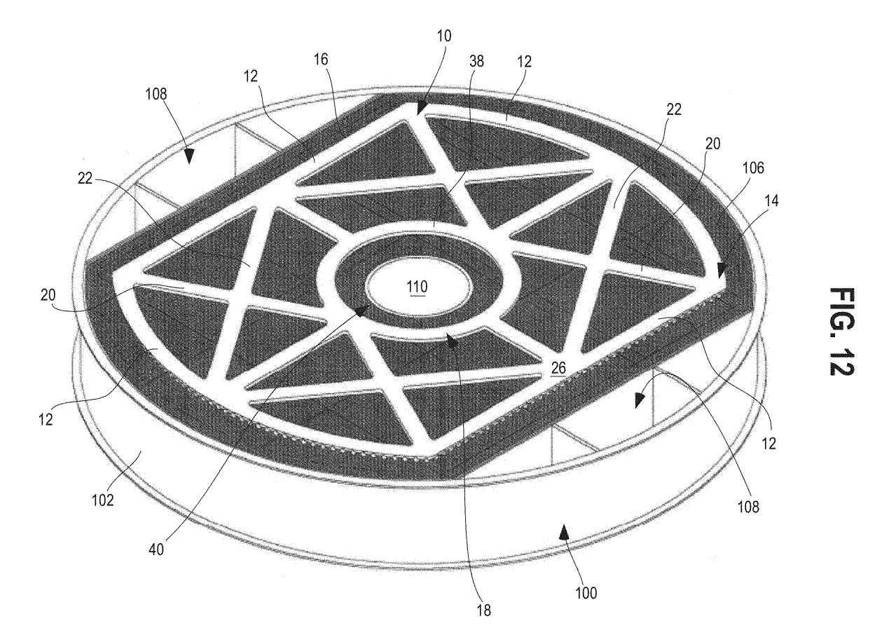

As shown in FIGS. 8 and 9, according to an exemplary embodiment, nubs 32 provided on bottom surfaces 30 of outer members 12 can be positioned adjacent to the outer edge of outer members. As shown, nubs 32 provided on interior members 20 and crossing members 22 can be generally centrally located between the side edges of members 20 and 22; however, nubs 32 provided on outer members 12 can be offset toward the outer edge of frame portion 16 rather than centrally located within the width of members 12. FIGS. 10A-10C illustrate a cross-section of interior members 20 and crossing members 22 showing nubs 32 (with different configurations of terminal ends 36) centrally positioned on bottom surface 30 of members 20 and 22. FIGS. 11A-11C illustrate a cross-section of outer members 12 showing nubs 32 (with different configurations of terminal ends 36) extending from bottom surface 30 along the outer edge of members 12. Such an alternative arrangement of nubs 32 across cleaning device 10 can be configured to adjust the force applied by nubs 32 to sieve screen 106 and the weight distribution of cleaning device 10 when cleaning device is used with sieve box 100. Nubs 32 on interior members 20 and crossing members 22 can also be positioned along one of the side edges of members 20 or 22 in certain embodiments of the present invention.

FIG. 12 illustrates another alternative embodiment of cleaning device 10 configured for use with a pneumatic sifting box 100. Pneumatic sifting box 100 as illustrated in FIG. 12 has general circular shape with discharge channels 108 provided on two sides of sifting box 10; however, it is recognized that sifting box 100 can be configured into several different types of shapes in alternative embodiments. Cleaning device 10 can be configured to generally conform to the shape of sieve screen 106 provided on sifting box 100 and can include outer members 12, interior members 20 and cross members 22 as described in previous embodiments. However, central region 18 according to the embodiment illustrated in FIG. 12 can comprise an outer ring member 38 and an aperture 40 that can be positioned around a pneumatic mechanism 110 provided in the central region of pneumatic sifting box 100. In operation, pneumatic mechanism 110 can be configured to move cleaning device 100 relative to sieve screen 106 by rotating and/or moving outer ring 38 of central region 18 around pneumatic mechanism 110.

Cleaning device 10 can be constructed and formed using any suitable or desired material or combination of materials. Cleaning device 10 can be formed of a generally flexible or rigid material, such as urethane, polyurethane, plastic, polymer, or any other suitable material now known or hereafter developed. Cleaning device 10 can be constructed or formed with reinforcing materials provided within outer members 12, interior members 20 and/or cross member 22 in certain embodiments of the present invention in order to increase the structural stability of cleaning device 10. According to one embodiment of the present invention, cleaning device 10 can be constructed using a mold system to form members 12, 20 and/or 22 into a single integrated component with a plurality of nubs 32 provided on the bottom surface 30 of cleaning device 10. Cleaning device 10 can also have a coating applied thereon in certain embodiments of the present invention.

Cleaning device 10 can also be configured with a desired hardness. According to one particular embodiment, cleaning device 10 is formed of a material having a durometer of between about 60A and about 120A, wherein in another embodiment, the material has a durometer of between about 70A and about 110A, and in yet another embodiment the material has a durometer of between about 80A and about 100A. The material from which cleaning device 10 is constructed, and its flexibility (or rigidity), can depend on the milling product being sifted, the mesh size of sieve screen 106, the aggressiveness level of nubs 32, and/or various other factors.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A cleaning device configured for use with a sieve box having a sieve screen, said cleaning device comprising:
a frame portion defining an outer perimeter of said cleaning device, said frame portion having a bottom surface;
at least one interior member extending inward from said frame portion, said at least one interior member having a bottom surface; and
a plurality of nubs provided on said bottom surfaces of said frame portion and said at least one interior member, wherein each nub of said plurality of nubs includes a terminal end;
wherein said cleaning device is configured for placement on a top surface of said sieve screen where said plurality of nubs contact said top surface of said sieve screen;
wherein said cleaning device is adapted to move across said sieve screen to remove a milling product contained on said sieve screen of said sieve box.

2. The cleaning device of claim 1, wherein said frame portion is configured into a diamond shape.

3. The cleaning device of claim 1, wherein said frame portion is configured into a rectangular shape, wherein at least one side of said frame portion includes two outer members intersecting to form a point.

4. The cleaning device of claim 1, further comprising a rib extending along at least a portion of said at least one interior member.

5. The cleaning device of claim 4, wherein said rib is provided on said bottom surface of said at least one interior member.

6. The cleaning device of claim 5, wherein said rib extends through at least a portion of said plurality of nubs provided on said at least one interior member.

7. The cleaning device of claim 1, wherein said terminal end of each said nub has a rounded shape.

8. The cleaning device of claim 1, wherein said terminal end of each said nub has a flattened shape.

9. The cleaning device of claim 1, wherein said terminal end of each said nub has a pointed shape.

10. The cleaning device of claim 1, wherein at least one of said plurality of nubs provided on said frame portion is centrally located along a width of said frame portion.

11. The cleaning device of claim 1, wherein at least one of said plurality of nubs provided on said frame potion is located along an outer edge of said frame portion.

12. A cleaning device configured for use with a sieve box having a sieve screen, said cleaning device comprising:
a plurality of outer members connected together to form an outer frame perimeter;
a central region positioned within said outer frame perimeter;
at least one interior member extending between said outer frame perimeter and said central region;
a bottom surface provided on said plurality of outer members and said at least one interior member; and
a plurality of nubs protruding from said bottom surface, said plurality of nubs spaced apart across said plurality of outer members and said at least one interior member;
wherein said cleaning device is adapted for placement on a top surface of said sieve screen and said nubs are adapted to break apart milling product contained on said sieve screen.

13. The cleaning device of claim 12, wherein said outer frame perimeter is configured into a diamond shape.

14. The cleaning device of claim 12, further comprising an elongated rib provided on said at least one interior member.

15. The cleaning device of claim 14, wherein said elongated rib is aligned with and extends through at least a portion of said plurality of nubs provided on said at least one member.

16. The cleaning device of claim 12, further comprising at least one void provided between said central region and said plurality of outer members.

17. The cleaning device of claim 12, wherein each nub of said plurality of nubs includes a terminal end, wherein said terminal end has one of a flattened shape, a rounded shape and a pointed shape.

18. The cleaning device of claim 12, wherein at least one of said plurality of nubs provided on said outer members is centrally located across a width of said outer members.

19. The cleaning device of claim 12, wherein at least one of said plurality of nubs provided on said outer members is positioned on an outer edge of said outer members.

20. A cleaning device configured for placement on a sieve screen of a sieve box to remove a milling product from said sieve screen, said cleaning device comprising:
a diamond-shaped outer frame portion;
an interior member extending inward from each corner of said outer frame portion toward a central region of said cleaning device;
a void provided between adjacent interior members;
a rib provided on a bottom surface of each said interior member, said ribs extending at least a portion of a length of said interior members; and
a plurality of nubs provided on a bottom surface of said outer frame portion and said bottom surface of said interior members;
wherein said nubs are configured to slide across said sieve screen and remove said milling product from openings contained within said sieve screen when said cleaning device is moved relative to said sieve box.
